(19) United States
(12) Patent Application Publication
(10) Pub. No.: US 2026/0233261 A1
(43) Pub. Date: Aug. 13, 2026

(54) SYSTEM AND METHOD FOR CLEANING WORKPIECES USING MULTIPHASIC LIQUIDS

(71) Applicant: The Boeing Company, Arlington, VA (US)

(72) Inventors: Nicholas G. Bible, Chesterfield, MO (US); Waynie M. Schuette, Troy, IL (US)

(73) Assignee: The Boeing Company, Arlington, VA (US)

(21) Appl. No.: 19/223,285

(22) Filed: May 30, 2025

Related U.S. Application Data
(60) Provisional application No. 63/757,451, filed on Feb. 12, 2025.

(51) Int. Cl. B08B 3/10; B08B 3/08

(52) U.S. Cl. CPC B08B 3/106; B08B 3/08; B08B 3/102

(57) ABSTRACT

A system for cleaning a workpiece comprises: a vaporization zone containing a first solvent and a second solvent, wherein the first and second solvents are at least partially immiscible with each other such that they form a liquid with at least two phases; a heating element configured to facilitate the vaporization of the first and second solvents, producing vaporized solvents; a condensing zone configured to receive the vaporized solvents from the vaporization zone; and a support configured to retain the workpiece in a position to receive the vaporized solvents for condensation on a surface of the workpiece.

### PRIORITY

This application claims priority from U.S. Ser. No. 63/757,451 filed on Feb. 12, 2025, the entire contents of which are incorporated herein by reference.

### FIELD

The present application relates to the field of cleaning systems, specifically systems and methods for cleaning workpieces using solvents, including immiscible solvents that form multiphasic liquids. These systems are applicable to industries such as electronics, aerospace, automotive, and medical device manufacturing, where precise and efficient cleaning is desired.

### BACKGROUND

Cleaning systems for workpieces are widely used across industries such as electronics, aerospace, automotive, and medical device manufacturing. These systems aim to remove contaminants like oils, greases, particulate matter, and residues resulting from manufacturing processes. Effective cleaning is essential to ensure the functionality, reliability, and safety of workpieces, especially in precision-critical applications.

Conventional cleaning methods often rely on single-phase solvent systems or aqueous solutions. Single-phase solvents, such as alcohols, hydrocarbons, or halogenated solvents, are commonly used due to their ability to dissolve specific contaminants. Similarly, aqueous systems are popular for their environmental friendliness and effectiveness against water-soluble contaminants. These methods are typically combined with agitation, heating, or mechanical cleaning techniques to improve their efficacy.

Aqueous cleaning systems leverage water-based solutions with surfactants to remove contaminants and are regarded as environmentally safer alternatives. Solvent-based systems, such as vapor degreasing, use solvent vapors to clean workpieces effectively and often incorporate heating and condensation zones for solvent recycling. These systems are well-known for their ability to remove a wide range of contaminants while maintaining operational efficiency.

Accordingly, those skilled in the art continue with research and development in the field of cleaning systems.

### SUMMARY

Disclosed are systems for cleaning a workpiece.

In one example, the disclosed system for cleaning a workpiece includes: a vaporization zone containing a first solvent and a second solvent, wherein the first and second solvents are at least partially immiscible with each other such that they form a liquid with at least two phases; a heating element configured to facilitate the vaporization of the first and second solvents, producing vaporized solvents; a condensing zone configured to receive the vaporized solvents from the vaporization zone; and a support configured to retain the workpiece in a position to receive the vaporized solvents for condensation on a surface of the workpiece.

Also disclosed are methods for cleaning a workpiece.

In one example, the disclosed method for cleaning a workpiece includes: providing a first solvent and a second solvent, wherein the first and second solvent are at least partially immiscible with each other such that they form a liquid with at least two phases; transferring vapors of the first and second solvent to a condensing zone; and condensing the vapors onto a surface of the workpiece to remove contaminants.

Other examples of the disclosed systems and methods will become apparent from the following detailed description, the accompanying drawings and the appended claims.

### BRIEF DESCRIPTION OF THE DRAWINGS

FIG. 1 is a schematic diagram illustrating an exemplary system for cleaning a workpiece.

FIG. 2 is a flow diagram illustrating an exemplary method for cleaning a workpiece.

FIG. 3 is a block diagram of aircraft production and service methodology.

FIG. 4 is a schematic illustration of an aircraft.

### DETAILED DESCRIPTION

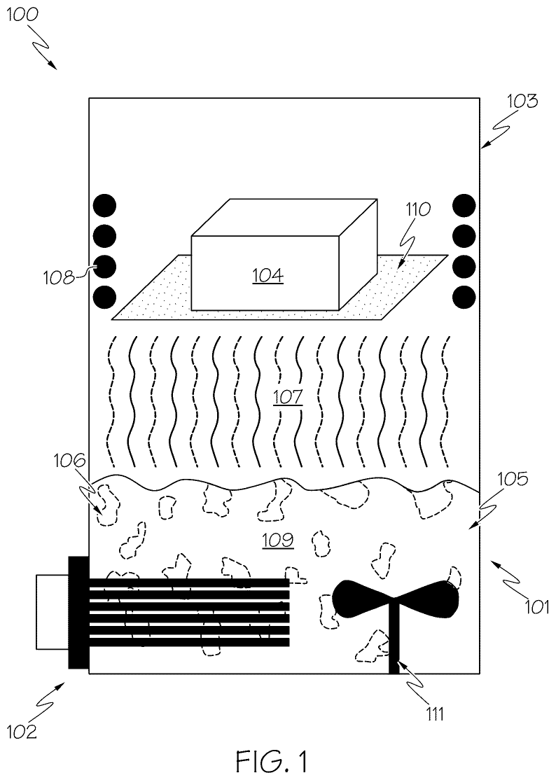

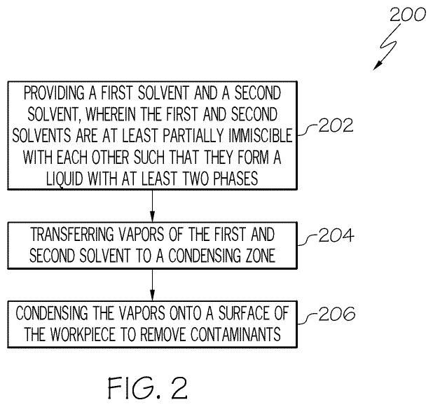

Referring to FIGS. 1 and 2, the present disclosure provides a system (100) and method (200) for cleaning a workpiece (104) using immiscible solvents that form multiphasic liquids (109), e.g., biphasic or triphasic liquids. The disclosed system comprises a vaporization zone (101), a heating element (102), a condensing zone (103), a support structure (110), and optional auxiliary components, such as an agitator (111) and a cooling element (108). These components operate collectively to produce and condense vaporized solvents for cleaning a workpiece (104). Detailed descriptions of each component and the associated process steps are provided below.

### System Overview

Referring to FIG. 1, the system (100) includes a vaporization zone (101) that contains a first solvent (105) and a second solvent (106). The solvents are immiscible and form a liquid with at least two phases (109). A heating element (102) is positioned to apply controlled heat to the multiphasic liquid (109) to generate mixed vapors (107) of the first and second solvents. These vapors ascend to a condensing zone (103), where they condense onto a workpiece (104) retained by a support structure (110). The condensing zone (103) includes a cooling element (108) that facilitates condensation of the mixed vapors (107) onto the surface of the workpiece (104). This condensed mixture aids in the removal of contaminants from the workpiece surface, providing efficient cleaning while minimizing structural complexity.

### Vaporization Zone (101)

The vaporization zone (101) is a primary chamber where the first solvent (105) and second solvent (106) are introduced and heated. These solvents are chosen for their immiscible properties, which result in distinct liquid phases (109) within the chamber. The solvents may include, for example, combinations of polar solvents, non-polar solvents, protic solvents, aprotic solvents, hydrocarbons, alcohols, esters, ethers, ketones, glycols, halogenated solvents, water-based solvents, or organic solvents.

The heating element (102) is configured to apply heat to the multiphasic liquid (109). Suitable heating elements include, for example, an electric resistance heating coil, a cartridge heater, a band heater, a plate heater, a tubular heater, an induction heating system, a heat exchanger, a steam jacket, an infrared heating system, a ceramic heater, a fluidized bed heater, a gas-fired heater, a microwave heating system, a laser heating system, and a combination thereof. In one aspect, the heating process may be controlled to operate below the boiling point of at least one solvent, as defined when the solvent is considered individually under the same pressure conditions. This creates an environment conducive to hydrodistillation-like effects, where the boiling points of the solvents are reduced through thermodynamic interaction. In one aspect, the heating process may be controlled to operate below the boiling point of at least two of the solvents, i.e., the first solvent (105) and the second solvent (106).

### Mixed Vapor Zone (107)

Positioned above the multiphasic liquid (109) is the mixed vapor zone (107). This transitional region captures vaporized solvents generated in the vaporization zone (101) and ensures uniform mixing of the solvent vapors. Mixed vapors (107) are then transferred to the condensing zone (103) for condensation and application onto the workpiece (104). As part of the process, the workpiece (104) may move through the condensation zone (103) into the mixed vapor zone (107). When the workpiece (104) is colder than the boiling point of the solvents, condensation will occur on the workpiece (104).

### Condensing Zone (103)

The condensing zone (103) is designed to receive the mixed vapors (107) and condense the vapors out of the air and onto the workpiece (104). The cooling element (108) provides a temperature gradient to facilitate this condensation. Cooling elements may include, for example, a cooling coil, a chilled plate, a heat exchanger, a refrigerated chamber, a thermoelectric cooler, a circulating coolant system, a cryogenic cooling element, a liquid nitrogen cooling system, a Peltier cooling module, a heat sink, or combinations thereof. The condensed solvents adhere to the surface of the workpiece (104), effectively dissolving contaminants and promoting thorough cleaning.

### Support Structure (110)

The support structure (110) typically retains the workpiece (104) in the mixed vapor zone (107) in a position that ensures optimal exposure to the mixed vapors (107). Suitable support structures include a mesh tray, a perforated platform, a solid platform, a hanger, a rack, a clamp, a frame, a rotary fixture, a non-stick surface, a porous holder, an adjustable fixture, a modular support assembly, a vibration-isolated platform, a spring-loaded holder, a magnetic fixture, and a combination thereof. The support structure (110) may alternatively be located in the condensing zone (103) if the workpiece reside below the cooling zone.

### Agitation and Auxiliary Components

In certain examples, the vaporization zone (101) includes an agitator (111) to promote uniform mixing of the multiphasic liquid (109). Suitable agitators include, for example, an ultrasonic agitator, a magnetic stirrer, an overhead stirrer, a paddle stirrer, a blade stirrer, an impeller, a vibrating plate, a recirculation pump, a mechanical shaker, a rotating drum, a bubbler, and a combination thereof. Agitation plays a role in maintaining the integrity of the multiphasic system by preventing phase separation. Phase separation occurs when the distinct liquid phases of the multiphasic liquid (109) segregate due to immiscibility, thereby reducing the surface area available for the interaction between phases. This separation diminishes the thermodynamic interaction, thereby lowering the overall efficiency of the vaporization process. Agitation ensures that both phases remain uniformly distributed across the surface of the liquid within the vaporization zone. By maintaining consistent interfacial contact between the phases, the system can sustain the combined vapor pressure required for effective boiling point suppression.

### Solvents

The solvents utilized in the disclosed system are selected to exploit their multiphasic properties, which are significant to the system's efficient operation. These properties allow for boiling point suppression, facilitated by a hydrodistillation-like effect. In this phenomenon, the immiscible solvents, when heated together, exhibit combined vapor pressures, resulting in reduced boiling points compared to their individual values. This interaction enables vaporization at lower temperatures, which is beneficial for energy efficiency, material compatibility, and enhanced cleaning performance.

The first and second solvents and additional optional solvents are chosen based on their immiscibility to ensure the formation of distinct liquid phases. These phases can be, for example, biphasic or triphasic, depending on the system configuration and the selected solvent combinations. The boiling points of these solvents typically range from about 30° C. to about 250° C. under standard atmospheric pressure, supporting a wide variety of cleaning applications while maintaining operational simplicity.

Polar and non-polar solvents are often paired to create a complementary system. Polar solvents, such as water, ethanol, isopropanol, methanol, acetone, propylene glycol, ethylene glycol, glycerol, dimethyl sulfoxide (DMSO), formamide, and acetonitrile, interact with non-polar solvents like hexane, heptane, pentane, toluene, xylene, benzene, cyclohexane, methyl butyrate, diethyl ether, decane, dodecane, and tetrahydronaphthalene (tetralin). This pairing ensures thorough cleaning by leveraging the distinct chemical properties of each solvent.

Protic and aprotic solvents may also be combined for specific applications. Protic solvents, including water, ethanol, isopropanol, methanol, glycerol, propylene glycol, and ethylene glycol, are effective for dissolving polar contaminants. Aprotic solvents, such as acetone, dimethyl sulfoxide (DMSO), acetonitrile, tetrahydrofuran (THF), dichloromethane, and trichloroethylene, provide excellent solvency for non-polar or less reactive substances, enhancing cleaning outcomes.

Certain configurations involve alcohols and hydrocarbons to balance the polarity spectrum. Alcohols like methanol, ethanol, isopropanol, butanol, pentanol, hexanol, and octanol are paired with hydrocarbons such as hexane, heptane, pentane, cyclohexane, toluene, xylene, benzene, decane, and dodecane. These combinations are particularly effective for removing a wide range of contaminants, from polar residues to hydrophobic substances.

In some setups, esters and ethers may be employed. Esters, including methyl acetate, ethyl acetate, propyl acetate, butyl acetate, and methyl butyrate, are combined with ethers such as diethyl ether, tetrahydrofuran (THF), dibutyl ether, and dimethyl ether to achieve a high degree of solubility for diverse contaminants. Glycols, such as ethylene glycol, propylene glycol, and glycerol, are sometimes combined with hydrocarbons for enhanced cleaning efficiency.

Halogenated solvents, including dichloromethane, chloroform, trichloroethylene, perchloroethylene, and carbon tetrachloride, may be paired with water-based solvents, such as water or aqueous surfactant solutions, to target specific cleaning challenges. Similarly, ketones like acetone, methyl ethyl ketone (MEK), and cyclohexanone are often used in conjunction with alcohols, such as methanol, ethanol, and isopropanol, to dissolve a wide range of contaminants.

In certain examples, the liquid within the vaporization zone forms a triphasic mixture, comprising three distinct phases. For example, a polar solvent, a non-polar solvent, and a glycol may be combined. Alternatively, combinations of an alcohol, hydrocarbon, and ether or an ester, glycol, and hydrocarbon may be utilized. Other potential mixtures include water, alcohol, and hydrocarbon; halogenated solvent, glycol, and ester; or alcohol, ketone, and hydrocarbon.

This diversity in solvent selection ensures that the systems and method of the present description can address a broad spectrum of contaminants while providing flexibility to meet specific cleaning requirements. The hydrodistillation-like effect resulting from these immiscible solvent combinations further enhances the system's operational efficiency and effectiveness.

### Method Overview

The method (200) for cleaning a workpiece begins with the introduction of immiscible solvents into the vaporization zone (101). These solvents are selected based on their ability to form at least two distinct liquid phases, such as biphasic or triphasic liquids (109). The first solvent (105) and second solvent (106) are chosen to complement each other, with combinations such as polar and non-polar, protic and aprotic, or other chemically distinct pairs. This immiscibility is crucial for creating a thermodynamic environment conducive to selective vaporization.

In the vaporization zone, controlled heat is applied to the liquid mixture using a heating element (102). The heating process may be designed to operate below the boiling point of one or more solvents, allowing the system to exploit a hydrodistillation-like effect. This effect reduces the boiling points of the solvents through their thermodynamic interaction, enabling energy-efficient vaporization. The heating element can be configured as, for example, an electric resistance coil, cartridge heater, or other suitable type, providing consistent and controlled thermal energy. Optional agitation, using devices such as a magnetic stirrer or ultrasonic agitator, enhances the uniform mixing of the liquid phases and improves heat transfer.

As the solvents vaporize, the mixed vapors (107) ascend into the mixed vapor zone (107). This transitional region ensures uniform mixing of the vaporized solvents, creating a homogeneous vapor composition to the extent that the solution is homogenized from agitation. From this zone, the vapors are directed to the condensing zone (103)

In the condensing zone, the mixed vapors are exposed to a cooling element (108), which creates a temperature gradient suitable for condensation. The cooling element may include a cooling coil, thermoelectric module, or other refrigerating systems. As the vapors condense, they adhere to the surface of the workpiece (104) retained in the condensing zone or mixed vapor zone by a support structure (110). Typically, vapors condense on a part when it is cold relative to the vapor. The support structure, in the condensing zone or mixed vapor zone, is designed to optimize the exposure of the workpiece to the condensed solvents, ensuring effective cleaning. The condensed solvents dissolve contaminants on the workpiece surface, which are subsequently removed. After the cleaning process, the condensed solvents and contaminants are collected for either disposal or reuse, completing the cleaning cycle.

FIG. 2 illustrates an exemplary method (200) for cleaning a workpiece, showing a sequential flow of operations, including introducing solvents, transferring vapors, and condensing the vapors to remove contaminants. While FIG. 2 depicts the core method, additional method steps and system components such as the vaporization zone, heating element, mixed vapor zone, condensing zone, and support structure can be included to work in coordination to achieve thorough and effective cleaning. The flexibility of this method accommodates various configurations, solvent combinations, and operational adjustments to meet specific cleaning requirements.

### Step (202): Providing a First Solvent and a Second Solvent

The first solvent and the second solvent are selected based on their immiscibility and introduced into the vaporization zone (101). The solvents form a liquid with at least two distinct phases (e.g., biphasic or triphasic), which is significant for the subsequent thermodynamic interaction.

### Step (204): Transferring Vapors to a Condensing Zone

The vapors generated from the multiphasic liquid are transferred to the condensing zone (103). This step ensures that the mixed vapors, which consist of components from both solvents, are delivered to the next phase of the cleaning process.

### Step (206): Condensing the Vapors on the Workpiece

In the condensing zone (103), the vapors are condensed using a cooling element (108). Additionally, the vapors may be condensed onto the workpiece if the part is colder than surrounding vapors. The condensed mixture dissolves and removes contaminants from the surface. This condensation ensures efficient cleaning while maintaining minimal structural complexity.

By way of example, consider a multiphasic liquid comprising water as the first solvent and methyl butyrate as the second solvent. The boiling points of the solvents under standard atmospheric pressure are 100° C. for water and 102° C. for methyl butyrate. The heating element may be configured to maintain the system at a temperature of less than 95° C., which is below the boiling point of both solvents individually under normal conditions. However, the thermodynamic interaction between the immiscible solvents causes a combined vapor pressure that exceeds what either solvent would achieve alone at this temperature. Water at 95° C. exerts a partial vapor pressure below 101.3 kPa, and methyl butyrate at 95° C. exerts a partial vapor pressure below 101.3 kPa. However, their combined vapor pressure exceeds 101.3 kPa. This enables the system to vaporize the mixture effectively, even though neither solvent independently reaches its boiling point. This hydrodistillation-like effect facilitates boiling point suppression and allows boiling to occur at less than 95° C., taking advantage of the immiscible nature of water and methyl butyrate. Operating near this elevated temperature increases the rate of vapor generation and enhances cleaning performance by ensuring more efficient contaminant removal. Additionally, the complementary chemical properties of water and methyl butyrate—water being highly polar and methyl butyrate offering effective solvency for organic contaminants—enable the system to address a broad spectrum of cleaning challenges. This example demonstrates how the system's design leverages thermodynamic principles to optimize cleaning efficacy while operating at controlled temperatures below the individual boiling points of the solvents.

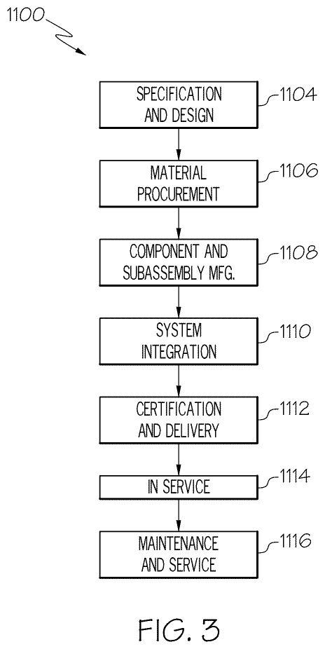

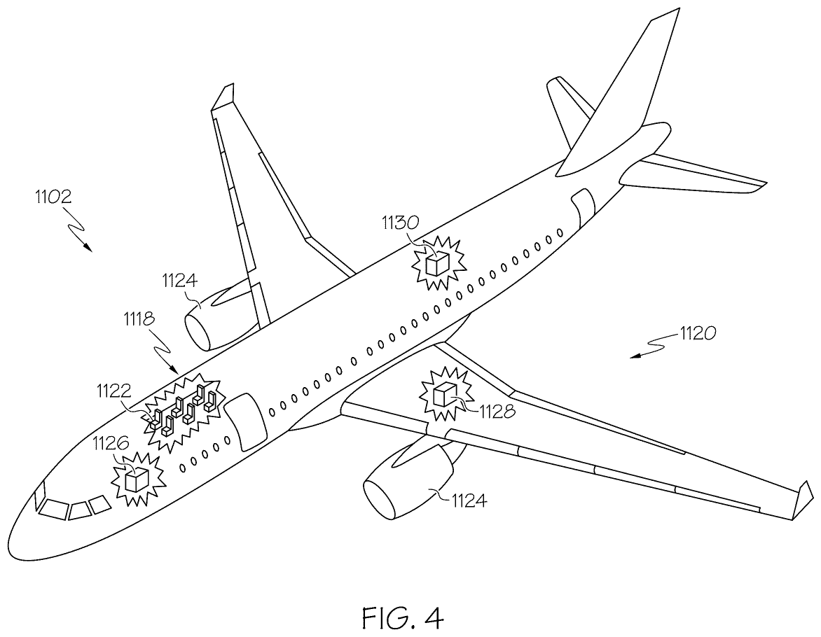

Examples of the subject matter disclosed herein may be described in the context of aircraft manufacturing and service method 1100 as shown in FIG. 3 and aircraft 1102 as shown in FIG. 4. During pre-production, illustrative method 1100 may include specification and design (block 1104) of aircraft 1102 and material procurement (block 1106). During production, component and subassembly manufacturing (block 1108) and system integration (block 1110) of aircraft 1102 may take place. Thereafter, aircraft 1102 may go through certification and delivery (block 1112) to be placed in service (block 1114). While in service, aircraft 1102 may be scheduled for routine maintenance and service (block 1116). Routine maintenance and service may include modification, reconfiguration, refurbishment, etc. of one or more systems of aircraft 1102.

Each of the processes of illustrative method 1100 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 4, aircraft 1102 produced by illustrative method 1100 may include airframe 1118 with a plurality of high-level systems 1120 and interior 1122. Examples of high-level systems 1120 include one or more of propulsion system 1124, electrical system 1126, hydraulic system 1128, and environmental system 1130. Any number of other systems may be included. Although an aerospace example is shown, the principles disclosed herein may be applied to other industries, such as the automotive industry. Accordingly, in addition to aircraft 1102, the principles disclosed herein may apply to other vehicles, e.g., land vehicles, marine vehicles, space vehicles, etc.

Apparatus(es) and method(s) shown or described herein may be employed during any one or more of the stages of the manufacturing and service method 1100. For example, components or subassemblies corresponding to component and subassembly manufacturing (block 1108) may be fabricated or manufactured in a manner similar to components or subassemblies produced while aircraft 1102 is in service (block 1114). Also, one or more examples of the apparatus(es), method(s), or combination thereof may be utilized during production stages (block 1108 and block 1110), for example, by substantially expediting assembly of or reducing the cost of aircraft 1102. Similarly, one or more examples of the apparatus or method realizations, or a combination thereof, may be utilized, for example and without limitation, while aircraft 1102 is in service (block 1114) and/or during maintenance and service (block 1116).

The disclosed system and method align with evolving environmental regulations by providing an alternative to traditional solvent-based cleaning systems that rely on hazardous materials such as trichloroethylene (TCE), perchloroethylene (PCE), and n-propyl bromide (nPB). These materials are facing increasing restrictions due to their environmental and health impacts. The present system leverages immiscible solvent combinations to achieve effective cleaning without relying on such restricted substances, offering an environmentally friendly and regulatory-compliant solution.

Unlike alternative vapor degreasing systems, which often require complex multi-sump configurations or high-vacuum setups, the disclosed system simplifies operations by enabling cleaning within a single sump. This design is made possible by the thermodynamic principles of hydrodistillation, which allow for boiling point suppression of immiscible solvents. The result is a system that reduces equipment costs, minimizes maintenance requirements, and enhances operational reliability.

The disclosed system is also highly adaptable to a range of industrial applications, including aerospace, automotive, electronics, and medical device manufacturing. For example, it is particularly suited for cleaning precision components such as landing gear, empennage honeycomb structures, and electronic assemblies, where thorough contaminant removal is critical to performance and reliability. Furthermore, the ability to customize solvent combinations allows the system to address a broad spectrum of contaminants, from salts, polar, non-polar, and Si/F containing compounds.

The flexibility of the disclosed method extends to its scalability and compatibility with existing cleaning infrastructure. The system can be integrated into current manufacturing processes with minimal modifications, providing a cost-effective pathway for industries transitioning from conventional solvent-based cleaning systems to more sustainable and versatile alternatives. Additionally, the disclosed system offers significant licensing potential for use in diverse industries, enabling widespread adoption of its innovative approach to cleaning.

The advantages of the disclosed system are further exemplified by its ability to balance energy efficiency with cleaning efficacy. By operating below the boiling points of the individual solvents while leveraging their combined vapor pressures, the system reduces energy consumption without compromising contaminant removal. This characteristic makes the disclosed system particularly appealing for industries seeking to optimize resource utilization while maintaining high-quality standards.

Although various examples of the disclosed systems and methods have been shown and described, modifications may occur to those skilled in the art upon reading the specification. The present application includes such modifications and is limited only by the scope of the claims.

1. A system for cleaning a workpiece, the system comprising:
a vaporization zone containing a first solvent and a second solvent, wherein the first and second solvents are at least partially immiscible with each other such that they form a liquid with at least two phases;
a heating element configured to facilitate vaporization of the first and second solvents, producing vaporized solvents;
a condensing zone configured to receive the vaporized solvents from the vaporization zone; and
a support configured to retain the workpiece in a position to receive the vaporized solvents for condensation on a surface of the workpiece.

2. The system of claim 1, wherein the first solvent and the second solvent have boiling points in a range of about 30° C. to about 250° C. under standard atmospheric pressure.

3. The system of claim 1, wherein the first solvent comprises at least one of a polar solvent, a non-polar solvent, a protic solvent, an aprotic solvent, a hydrocarbon, an alcohol, a ketone, an ester, an ether, a halogenated solvent, a glycol, a water-based solvent, an organic solvent, and a combination thereof.

4. The system of claim 1, wherein the second solvent comprises at least one of a polar solvent, a non-polar solvent, a protic solvent, an aprotic solvent, a hydrocarbon, an alcohol, a ketone, an ester, an ether, a halogenated solvent, a glycol, a water-based solvent, an organic solvent, and a combination thereof.

5. The system of claim 1, wherein the first solvent is polar and the second solvent is non-polar.

6. (canceled)

7. The system of claim 1, wherein the first solvent is protic and the second solvent is aprotic.

8. (canceled)

9. The system of claim 1, wherein the first solvent is an alcohol and the second solvent is a hydrocarbon.

10. (canceled)

11. The system of claim 1, wherein the first solvent is an ester and the second solvent is an ether.

12. (canceled)

13. The system of claim 1, wherein the first solvent is a glycol and the second solvent is a hydrocarbon.

14. (canceled)

15. The system of claim 1, wherein the first solvent is a halogenated solvent and the second solvent is a water-based solvent.

16. (canceled)

17. The system of claim 1, wherein the first solvent is a ketone and the second solvent is an alcohol.

18. (canceled)

19. The system of claim 1, wherein the first solvent is a water-based solvent and the second solvent is a hydrocarbon.

20. (canceled)

21. The system of claim 1, wherein the liquid in the vaporization zone is biphasic.

22. The system of claim 1, wherein the liquid in the vaporization zone is triphasic.

23. The system of claim 22, wherein the liquid in the vaporization zone comprises a polar solvent, a non-polar solvent, and a glycol.

24-29. (canceled)

30. The system of claim 1, wherein the heating element comprises at least one of an electric resistance heating coil, a cartridge heater, a band heater, a plate heater, a tubular heater, an induction heating system, a heat exchanger, a steam jacket, an infrared heating system, a ceramic heater, a fluidized bed heater, a gas-fired heater, a microwave heating system, a laser heating system, and a combination thereof.

31. The system of claim 1, wherein the condensing zone comprises a cooling element configured to facilitate condensation of the vaporized solvents onto the workpiece.

32. (canceled)

33. The system of claim 1, wherein the support comprises at least one of a mesh tray, a perforated platform, a solid platform, a hanger, a rack, a clamp, a frame, a rotary fixture, a non-stick surface, a porous holder, an adjustable fixture, a modular support assembly, a vibration-isolated platform, a spring-loaded holder, a magnetic fixture, and a combination thereof.

34. The system of claim 1, wherein the vaporization zone comprises an agitator.

35. (canceled)

36. A method for cleaning a workpiece, the method comprising:
providing a first solvent and a second solvent, wherein the first and second solvent are at least partially immiscible with each other such that they form a liquid with at least two phases;
transferring vapors of the first and second solvent to a condensing zone; and
condensing the vapors onto a surface of the workpiece to remove contaminants.

37-41. (canceled)
